(19) United States
(12) Patent Application Publication
(10) Pub. No.: US 2019/0016485 A1
(43) Pub. Date: Jan. 17, 2019

(54) DEVICE FOR SIMULTANEOUSLY MOLDING AND FILLING CONTAINERS FROM PREFORMS, VALVE ARRANGEMENT AND USE OF SUCH A VALVE ARRANGEMENT IN A METHOD FOR SIMULTANEOUSLY MOLDING AND FILLING CONTAINERS FROM PREFORMS

(71) Applicant: KHS Corpoplast GmbH, Hamburg (DE)

(72) Inventors: Michael LITZENBERG, Geesthacht (DE); Michael LINKE, Hamburg (DE); Werner LESINSKI, Ahrensburg (DE)

(21) Appl. No.: 15/773,103

(22) PCT Filed: Nov. 10, 2016
(86) PCT No.: PCT/EP2016/077239

§ 371 Date: May 2, 2018

(30) Foreign Application Priority Data
Nov. 11, 2015 (DE) 10 2015 014 462.6

(51) Int. Cl. B65B 3/02; B29C 49/46; B29C 49/42; B29C 49/12; B29C 49/28; B65B 3/10; F16K 1/12; F16K 31/44

(52) U.S. Cl. CPC B65B 3/022; B29C 49/46; B29C 49/4273; B29C 49/12; B29C 49/4289; B29L 2031/7158; B65B 3/10; F16K 1/123; F16K 31/445; B29C 2049/4664; B29C 49/28

(57) ABSTRACT

A device and method for producing a filled container from a preform using liquid contents introduced under pressure into the preform that includes a molding and filling station having a mold in which the preform is converted into the filled container and a molding and filling head to which the liquid contents are supplied under pressure via a supply line. The molding and filling head has a filling valve for controlling a supply of the liquid contents to the preform that includes a first and a second pipe stub of substantially identical diameter arranged at a distance from one another, a valve body arranged between the stubs having a largest diameter that corresponds to the diameter of the pipe stubs, and a sleeve that is displaceable along and bridges the distance between the pipe stubs in a leak-tight manner. The sleeve has a maximum internal diameter that is greater than the largest diameter of the valve body, and is displaceable along the pipe stubs such that, in a closed position of the valve arrangement, the sleeve is in contact with a sealing surface arranged on the valve body that has a diameter that is substantially the same as the diameter of the pipe stubs.

The present invention relates to a device for simultaneously molding and filling containers from preforms, a valve arrangement, and use of such a valve arrangement in a method for simultaneously molding and filling containers from preforms.

Conventionally, containers, in particular bottles, are molded in the blow-molding process by a molding gas flowing under pressure into a preheated preform and, in a second step, are filled with contents, in particular liquid contents. For more rational production, methods have recently been developed in which the preheated preform is not formed and filled by a compressed gas but, in one step, by the liquid contents supplied under pressure. Such a method is known, e.g., from DE 10 2010 007 541 A1.

So that a preform can be converted into a container, it is thermally conditioned, that is, in particular heated and provided with a suitable temperature profile. In this case, the body of the preform is heated, e.g., to approx. 120° C. and can be molded, while the mouth region may reach only significantly lower temperatures, since the preform is held at the mouth region in the molding and filling machine and must not deform under the usual holding forces there. For thermal conditioning, a device for producing filled containers has a heating section, along which the preforms are guided while being provided with the desired temperature profile.

The molding process must then proceed very rapidly so that the heat stored in the preform is sufficient to maintain the preform in a plastically deformable state until completion of the molding process. Therefore, when molding with liquid contents, the volume required for the molded container must be supplied to the preform under high pressure and within a short time interval. Flow rates of up to 20 liters/s and more at pressures up to 40 bar are required.

Conventional valves are for example piston valves, which are flowed through coaxially, and in which a centrically arranged piston is moved axially to close the valve seat or to release the valve cross-section. However, large reaction forces act on the piston of such a valve during opening and closing, caused by the pressure-loaded control surfaces of different sizes. Large control forces are required, which can lead to a delayed response of the valve and to only slow opening or closing. In a combined molding and filling method, the short filling times can be achieved only with great effort.

The invention has the object of proposing a device for producing filled containers from preforms using liquid contents introduced under pressure into the preform, which device is provided with a filling valve that can be actuated with short reaction times. It is another object of the invention to propose a valve arrangement that can be controlled with little effort even when used in piping systems with high pressure and allows high flow rates.

The object according to the invention is achieved by a device for producing filled containers from preforms using liquid contents introduced under pressure into the preform, comprising a molding and filling station with a mold in which a preform can be converted into a filled container, and a molding and filling head to which contents can be supplied under pressure via a supply line, and which has a filling valve for controlling the supply of contents to the preform. The device according to the invention is characterized by a filling valve having a valve arrangement that comprises a first and a second pipe stub of identical diameter. The two pipe stubs are arranged at a distance from one another. A valve body, the diameter of which at least corresponds to the diameter of the pipe stubs is arranged between the pipe stubs. The valve arrangement also comprises a sleeve which can be displaced along the two pipe stubs and which bridges the gap between the two pipe stubs in a leak-tight manner, wherein the sleeve has a maximum internal diameter that is greater than the maximum diameter of the valve body. The sleeve can be displaced along the pipe stubs such that, in a closed position of the valve arrangement, it is in contact with a sealing surface arranged on the valve body, and such that the sealing surface has the same diameter as the pipe stubs.

The valve arrangement of the device according to the invention comprises two pipe stubs for connecting to a pipe system. The pipe stubs both have the same diameter. They are arranged at a distance and are bridged in a leak-tight manner by a sleeve which can be displaced along the pipe stubs. It is irrelevant in this case whether the sleeve surrounds the pipe stubs from the outside or is inserted inside the pipe stubs. The wall thickness of the pipe stubs is assumed to be negligible with respect to the diameter. If this is not the case, the internal diameter should be used as the diameter when the sleeve engages inside the pipe stubs, and the outer diameter should be used when the sleeve engages around the outside of the pipe stubs.

A valve body is arranged between the pipe stubs, wherein the largest diameter of said valve body corresponds to at least the diameter of the pipe stubs. The sleeve has a maximum internal diameter greater than the maximum diameter of the valve body such that a flow path is enabled between the valve body and the sleeve in an open position of the valve arrangement.

The sleeve can be displaced along the pipe stubs such that it can be transferred from an open to a closed position in which the sleeve is in contact with a sealing surface on the valve body and interrupts the flow path. The sealing surface should be arranged on the valve body such that its diameter corresponds to the diameter of the pipe stubs. If the valve is closed and the flow is interrupted, only the line upstream is pressurized, while the line downstream is pressure-free. In contrast to conventional valves, the applied pressure exerts no force on the valve actuation since the surfaces in the actuating element of the valve—here, the sleeve—are the same size in both directions of actuation. The valve can therefore be actuated with minimal forces.

The valve body may have at least in sections, in particular, a conical shape, a truncated cone shape, a hemispherical shape, a spherical segment shape or a spherical shape.

Two symmetrical truncated cones attached at their base, or a sphere as a valve body, permit valve actuation in both directions, so that a closing position is reached in each case in the end position.

The sleeve of the valve arrangement according to the invention is configured preferably rotationally symmetrically. But, other shapes are also possible, especially in the area of the flow path outside the sealing surfaces between the valve body and sleeve.

The valve body is preferably connected in a suitable manner with at least one of the two pipe stubs, such that the connecting elements do not significantly restrict the flow path or obstruct the flow.

In a device for molding and filling containers from preforms, the valve arrangement can advantageously have a stretching rod, which is arranged displaceably in the axial direction in the valve arrangement and passes through the valve body. By the fact that the valve arrangement can be controlled by the outer sleeve and not by a movement of the valve body, the stretching rod can be particularly easily introduced into the valve arrangement. There is no interference with internal control elements for the valve body, since the valve body is arranged fixed in position in the valve.

The object of the invention is also achieved by a valve arrangement comprising a first and a second pipe stub with the same diameter. The two pipe stubs are arranged at a distance from one other. A valve body, the diameter of which at least corresponds to the diameter of the pipe stubs, is arranged between the pipe stubs. The valve arrangement also comprises a sleeve which can be displaced along the two pipe stubs and which bridges the gap between the two pipe stubs in a leak-tight manner, wherein the sleeve has a maximum internal diameter that is greater than the maximum diameter of the valve body. The valve arrangement according to the invention is characterized in that the sleeve can be displaced along the pipe stubs in such a way that, in a closed position of the valve arrangement, it is in contact with a sealing surface arranged on the valve body, and that the sealing surface has the same diameter as the pipe stubs. A valve arrangement according to the invention can advantageously have the features already described above in connection with the device according to the invention for producing filled containers from preforms.

A filling valve with the characteristics of the valve arrangement described above can be controlled with little force and with short reaction times.

For the supply of contents to a preform for molding and filling within the very short filling times, which must be achieved in the hydraulic molding and simultaneous filling of containers, a rapid build-up of the full filling pressure and the total volume flow of the contents is required. Delays in the build-up of the filling pressure due to a slowly opening valve on the one hand lead to extended filling times, which can lead to undesired cooling of a thermally conditioned preform, so that the preform is no longer sufficiently deformable. On the other hand, a volume flow which is insufficient in the initial phase of the molding and filling process can lead to undesired material distributions during the conversion of the preform into the container.

In a device according to the invention, it is particularly advantageous to use a valve which has a closed position in each end position. As a result, during a molding and filling process, which typically takes between 100 and 150 ms, no reversal of movement is required to first open the valve and then close it again. It only requires a linear movement that take place with little force and low inertia within the short time available. The opposite movement takes place in the next molding and filling cycle.

The device according to the invention can advantageously have a stretching rod which can pass through the valve body of the valve.

Exemplary embodiments of the invention are explained in more detail below with reference to the appended figures, which show the following:

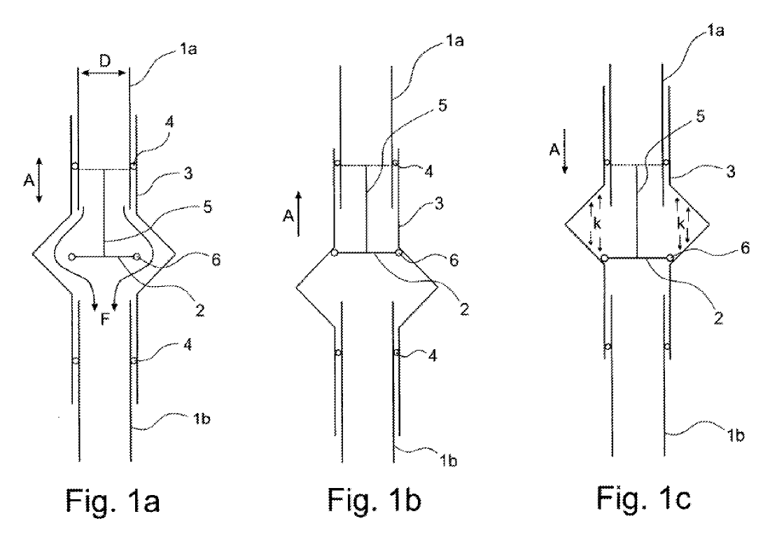

FIGS. 1a, 1b and 1c show schematically a valve arrangement according to the invention with a disk-shaped valve body in cross section in the open and closed position;

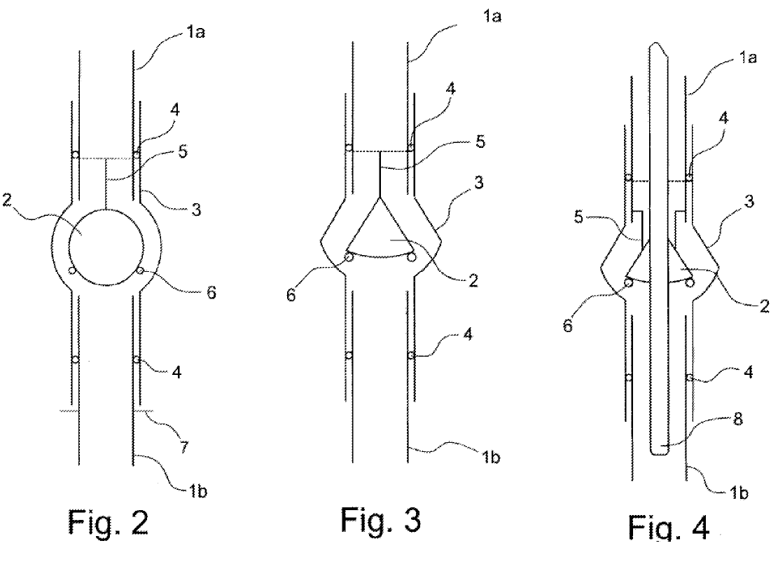

FIG. 2 shows schematically a valve arrangement according to the invention with a spherical valve body in cross section;

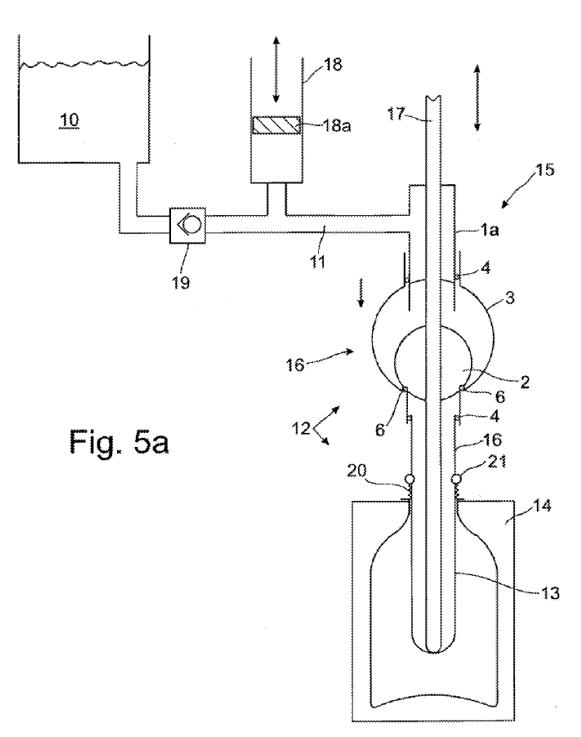

FIG. 3 shows schematically a valve arrangement according to the invention with a truncated cone valve body in cross section;

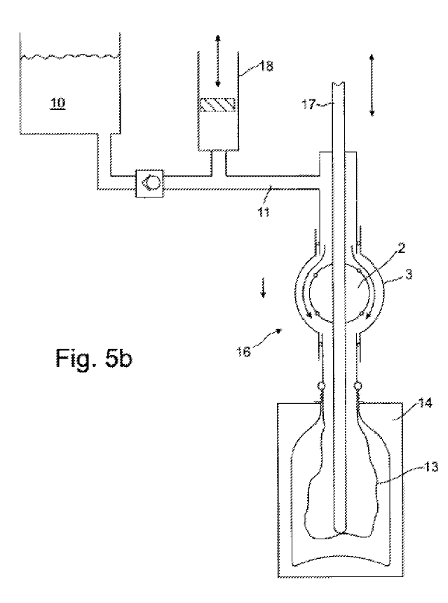

FIG. 4 shows the arrangement of FIG. 3 with an additional stretching rod passing through the valve body;

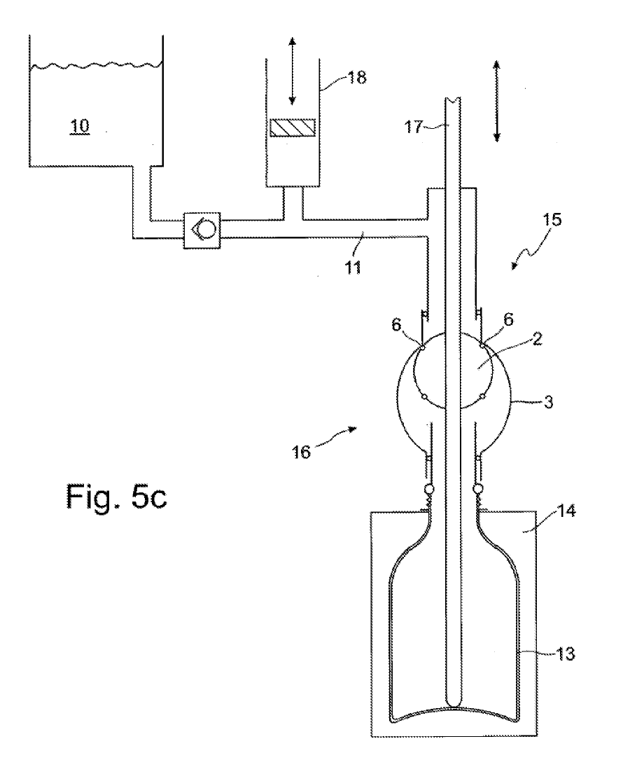

FIGS. 5a to 5c show schematically a device for producing filled containers from preforms using liquid contents introduced under pressure into the preform, which device is equipped with a valve according to the invention, in different phases of the molding and filling process.

The person skilled in the art will appreciate that the drawings shown here are merely intended to illustrate the principle of the invention and are only reproduced schematically and not to scale. In particular, the illustrated dimensions and proportions of the elements are provided for illustrative purposes only. The actual dimensions and proportions can be freely determined by the person skilled in the art on the basis of his expert knowledge. In addition, only the components required for understanding the invention are shown. Real devices may include further components.

FIG. 1a shows a valve arrangement according to the invention in cross section, comprising a first pipe stub 1a and a second pipe stub 1b. The two pipe stubs 1a, 1b are arranged at a distance from one another and have the same diameter D. A sleeve 3 bridges the gap between the two pipe stubs and can be displaced in the direction of arrow A. The sleeve is sealed against the pipe stubs by the seals 4.

A disk-shaped valve body 2 is located at a distance between the two pipe stubs 1a, 1b and is connected with the first pipe stub 1a via a suitable retaining element 5, so that the retaining element does not substantially obstruct the flow in the valve arrangement.

At its edge, the valve body 2 has a sealing surface 6, which has at least approximately the diameter of the pipe stubs 1a, 1b.

The maximum internal diameter of the sleeve 3 is greater than the maximum diameter of the valve body 2, so that in the open position illustrated, a liquid flow can flow around the valve body 2 in the direction of the arrows F.

In FIG. 1b, the valve of FIG. 1a is shown in the closed position. In this case, the sleeve 3 is displaced downwards. In this case, a surface of the sleeve 3 comes into contact with the sealing surface 6 on the valve body 2, such that the liquid flow through the valve is interrupted. The liquid in the line is in the valve. The second pipe stub 1b is free of liquid and free of pressure. By the pressure in the first pipe stub 1a and in a part of the sleeve 3, no forces are exerted in the actuating direction A of the sleeve 3, so that the sleeve 3 can be moved almost without force, and the valve can be controlled in this manner.

In FIG. 1c, the valve of FIGS. 1a and 1b is shown again in the closed position. In this case, the sleeve 3 is in the upper closed position. Due to the symmetrical structure of both the sleeve 3 and the valve body 2, the valve closes in both end positions, such that there are different ways of attaching control elements, depending on the surroundings of the installation position. In this closed position, liquid is under pressure in large areas of the sleeve. The forces exerted by the pressure on the sleeve 3 in the direction of the actuating direction A of the sleeve 3 cancel each other out because of the geometry of the surfaces, since the sealing surface 6 is arranged in alignment with the seals 4 between pipe stubs 1a, 1b and sleeve 3. The force components K acting on the walls cancel each other out.

FIG. 2 shows a valve arrangement, which works like the valve arrangement shown in FIGS. 1a through 1 c, in the open position. However, the valve body 2 is a sphere that improves the flow in the valve arrangement as compared to the plate shown in FIG. 1. The maximum diameter of the sphere is greater than the diameter of the pipe stubs 1a, 1b. The sleeve 3 is adapted to the spherical shape accordingly to produce a sealing surface 6, which corresponds to the diameter of the pipe stubs. The displacement path of the sleeve is limited by a stop 7 such that it can be transferred only from the illustrated open position to a closed position.

FIG. 3 shows a valve arrangement as shown in FIG. 2, but with a truncated cone valve body 2, which terminates slightly rounded in its downstream area. This is intended to achieve a flow with as little turbulence as possible. The functionality is unchanged and as described above.

FIG. 4 shows the valve arrangement of FIG. 3 with a stretching rod passing through the valve body, which can be displaced vertically in the valve body 2. The valve is thus suitable for use in a system for producing filled containers from preforms by introducing the contents into the preform under high pressure. The preform must be stretched in the axial direction, in particular at the beginning of the molding phase. In conventional valves with a movable piston in the valve, this is sometimes difficult to implement. The valve arrangement according to the invention opens up a range of possibilities in this regard.

FIG. 5a schematically shows a device for producing filled containers from preforms using liquid contents introduced under pressure into the preform, which is equipped with a valve according to the invention.

The device comprises a contents reservoir 10, from which the contents can be supplied to a molding and filling station 12 through a supply line 11. There the preform 13 is present in a mold 14. The preform was previously thermally conditioned along a heating section, not shown here, so that it is plastically deformable.

The molding and filling station further comprises a molding and filling head 15 with a filling valve 16 and a stretching rod 17, by means of which the preform or the forming container can be stretched and guided in the axial direction.

The contents supplied from the reservoir 10 is pressurized in the supply line 11, for which purpose suitable means such as the piston pump 18 shown here, or any other suitable pump, can be used. The reservoir 10 is closed by a check valve 19 against the pressure within the supply line 11.

For the simultaneous molding and filling of a container, the required molding and filling pressure of approximately 38 bar is built up in the supply line 11. For this purpose, the required amount of contents is drawn into the piston pump 18 and then the desired pressure is built up by the piston 18a. The molding and filling valve 16 is initially closed, such that no contents can leak, and the full pressure can be built up.

The molding and filling valve 16 is a valve as described above. It has a valve body 2, which is arranged between two pipe stubs 1a, 1b. The two pipe stubs are bridged by the seals 4 in a leak-tight manner through the pipe stub 3. In the position illustrated, the pipe stub 3 is in contact with the sealing surface 6 of the valve body, so that the valve is closed.

The molding and filling head 15 is then placed in a leak-tight manner on the mouth 20 of the preform 13, for which a seal 21 is provided on the molding and filling head. The stretching rod 17, which passes through the valve body 2, is moved down into the bottom of the preform 13.

The entire molding and filling process may take only about 100 to 150 ms, so that the temperature of the thermally conditioned preform 13 is still sufficient to allow plastic deformation. The volume flow of the contents must be correspondingly high. It is therefore necessary to open the filling valve 16 and to close it again sufficiently quickly.

Using the valve according to the invention, this is done without much effort by moving the sleeve 3 downwards.

In FIG. 5b, the device is shown in the middle of the molding and filling process. The sleeve 3 of the filling valve 16 is displaced downwards into a middle position, allowing the flow of contents around the valve body 2. The sleeve 3 can, as explained in detail above, be displaced almost without force, whereby the maximum valve cross section can be released quickly, and the contents can be supplied under the desired pressure and high flow rate to the preform 13, which is converted to the container. The stretching rod 17 stretches the preform 13 at the beginning of the molding and filling process and then guides the bottom of the preform, so that the molding of the container can be done evenly and the bottom of the forming container can not move laterally.

FIG. 5c shows the device from FIGS. 5a and 5b upon completion of the molding and filling process. The container 13 is completely filled and molded, and abuts against the wall of the mold 14. The sleeve 3 of the filling valve 16 is displaced all the way down, where in turn there is a closed position of the valve and no contents is supplied. The container can thus be separated from the molding and filling head 15 and further processed, in particular by closing, labeling, etc.

For the next molding and filling process, the piston pump 18 can draw again contents from the reservoir 10 and pressurize it within the supply line 11. The molding and filling process takes place then again in the manner described above, wherein the sleeve 3 of the molding and filling valve 16 is moved upward in this cycle, to arrive again in the starting position of FIG. 5a.

The molding and filling process can be controlled particularly efficiently with the valve described, since the valve can be opened and closed virtually without force. In addition, the sleeve 3 must perform only a linear movement per molding and filling process. A reversal of the direction of movement, which would be associated with a certain inertia, is not required. The valve can be quickly fully opened and closed in the required short filling time, so that the required volume flow can be achieved almost immediately.

1. A device for producing a filled container from a preform using liquid contents introduced under pressure into the preform, the device comprising:
a molding and filling station having a mold in which the preform is converted into the filled container; and
a molding and filling head to which the liquid contents are supplied under pressure via a supply line, said molding and filling head having a filling valve for controlling a supply of the liquid contents to the preform;
wherein the filling valve has a valve arrangement,
wherein said valve arrangement comprises:
a first and a second pipe stub of substantially identical diameter, the first and second pipe stubs being arranged at a distance from one another,
a valve body arranged between the first and second pipe stubs, said valve body having a largest diameter that is identical to or larger than the diameter of the first and second pipe stubs, and
a sleeve that is displaceable along the first and second pipe stubs and that bridges the distance between the first and second pipe stubs in a leak-tight manner,
wherein the sleeve has a maximum internal diameter that is greater than the largest diameter of the valve body, and
wherein the sleeve is displaceable along the first and second pipe stubs such that, in a closed position of the valve arrangement, the sleeve is in contact with a sealing surface arranged on the valve body, and
wherein a diameter of the sealing surface is substantially the same as the diameter of the first and second pipe stubs.

2. The device according to claim 1, wherein the valve body of the valve arrangement has, at least in sections, approximately a conical shape, a truncated cone shape, a hemispherical shape, a spherical segment shape or a spherical shape.

3. The device according to claim 1, wherein the sleeve of the valve arrangement is constructed rotationally symmetrical.

4. The device according to claim 1, wherein the valve body of the valve arrangement is attached to at least one of the two first and second pipe stubs.

5. The device according to claim 1, wherein the molding and filling head comprises a stretching rod which passes through the valve body of the valve arrangement.

6. A valve arrangement, comprising
a first and a second pipe stub of substantially identical diameter, the first and second pipe stubs being arranged at a distance from one another,
a valve body arranged between the first and second pipe stubs, said valve body having a largest diameter that is identical to or larger than the diameter of the first and second pipe stubs, and
a sleeve that is displaceable along the first and second pipe stubs and that bridges the distance between the first and second pipe stubs in a leak-tight manner,
wherein the sleeve has a maximum internal diameter that is greater than the largest diameter of the valve body,
wherein the sleeve is displaceable along the first and second pipe stubs such that, in a closed position of the valve arrangement, the sleeve is in contact with a sealing surface arranged on the valve body, and
the sealing surface has a diameter that is substantially the same as the diameter of the first and second pipe stubs.

7. The valve arrangement according to claim 6, wherein the valve body of the valve arrangement has, at least in sections, approximately a conical shape, a truncated cone shape, a hemispherical shape, a spherical segment shape or a spherical shape.

8. The valve arrangement according to claim 6, wherein the sleeve of the valve arrangement is rotationally symmetrical.

9. The device according to claim 6, wherein the valve body is attached at least to one of the first and second pipe stubs.

10. The device according to claim 6, wherein the valve arrangement comprises a stretching rod which passes through the valve body.

11. A method of molding and filling containers a container from a preform, the method comprising providing a valve arrangement according to claim 6, and introducing liquid contents under pressure into the preform by means of the valve arrangement to mold the preform into the container and to fill the container with the liquid contents.
